(19) United States
(12) Patent Application Publication
(10) Pub. No.: US 2024/0383795 A1
(43) Pub. Date: Nov. 21, 2024

(54) 3D PRINTED LAYERED GLASS STRUCTURE HAVING INCREASED MECHANICAL STRENGTH

(71) Applicant: CORNING INCORPORATED, CORNING, NY (US)

(72) Inventors: Soon-yong Choi, Guri-si (KR); EunHwa Kim, Cheonan-si (KR); Hyung Soo Moon, Gangnam-gu (KR)

(21) Appl. No.: 18/695,953

(22) PCT Filed: Sep. 20, 2022
(86) PCT No.: PCT/US22/44079

§ 371 Date: Mar. 27, 2024

Related U.S. Application Data
(60) Provisional application No. 63/250,260, filed on Sep. 30, 2021.

(51) Int. Cl. C03B 23/203; B33Y 10/00; B33Y 70/00; B33Y 80/00; C03B 19/06

(52) U.S. Cl. CPC C03B 23/203; B33Y 10/00; B33Y 70/00; B33Y 80/00; C03B 19/063

(57) ABSTRACT

A layered glass structure includes an inner layer having opposing major surfaces. The inner layer includes a first glass powder and a first inorganic filler. The inner layer has a first coefficient of thermal expansion (CTE) and a first transition temperature (Tg). An outer layer is disposed on each opposing major surface of the inner layer. The outer layer includes a second glass powder and a second inorganic filler. The outer layer has a second CTE and a second Tg. A CTE gap between the first CTE and the second CTE is between 10×10⁻⁷/° C. and 30×10⁻⁷/° C. A difference between the first Tg and the second Tg is 10° C. or less.

### CROSS-REFERENCE TO RELATED APPLICATIONS

This application claims the benefit of priority under 35 U.S.C. § 119 of U.S. Provisional Application No. 63/250,260 filed Sep. 30, 2021, the content of which is incorporated herein by reference in its entirety.

### FIELD OF THE DISCLOSURE

The present disclosure relates to a layered glass structure. More specifically, the present disclosure relates to a three-dimensional (3D) printed layered glass structure having increased mechanical strength.

### BACKGROUND

Three-dimensional printing is generally a technology that produces a three-dimensional structure from two-dimensional printed layers of material. A variety of materials may be used for 3D printing. There are multiple techniques for 3D printing.

### SUMMARY OF THE DISCLOSURE

According to at least one aspect of the present disclosure, a layered glass structure includes an inner layer having opposing major surfaces and includes a first glass powder having a first powder coefficient of thermal expansion (CTE) and a first powder transition temperature (Tg). The inner layer includes a first inorganic filler. The inner layer includes a predefined ratio between the first glass powder and the first inorganic filler. The inner layer has a first overall CTE higher than the first powder CTE and a first overall Tg higher than the first powder Tg. An outer layer is disposed on at least two opposing major surfaces of the inner layer. The outer layer includes a second glass powder having a second powder CTE and a second powder Tg. The outer layer includes a second inorganic filler. The outer layer includes a predefined ratio between the second glass powder and the second inorganic filler. The outer layer has a second overall CTE lower than the second powder CTE and lower than the first overall CTE and a second overall Tg higher than the second powder Tg. A difference between the first overall Tg and the second overall Tg is less than 15° C.

According to another aspect of the present disclosure, a layered glass structure includes an inner layer having opposing major surfaces. The inner layer includes a first glass powder and a first inorganic filler. The inner layer has a first coefficient of thermal expansion (CTE) and a first transition temperature (Tg). An outer layer is disposed on each opposing major surface of the inner layer. The outer layer includes a second glass powder and a second inorganic filler. The outer layer has a second CTE and a second Tg. A CTE gap between the first CTE and the second CTE is between 10×10⁻⁷/° C. and 30×10⁻⁷/° C. A difference between the first Tg and the second Tg is 10° C. or less.

According to another aspect of the present disclosure, a method of manufacturing a layered glass structure includes forming a first mixture having a predefined ratio of a first glass powder and a first inorganic filler; forming a second mixture having a predefined ratio of a second glass powder and a second inorganic filler; printing a first layer including the first mixture, where the first layer has a first transition temperature (Tg) and a first coefficient of thermal expansion (CTE) lower than a CTE of the first glass powder; printing a second layer comprising the second mixture on the first layer, the second layer having a second Tg and a second CTE higher than a CTE of the second glass powder and higher than the first CTE; printing a third layer including the first mixture on the second layer, where the third layer has the first CTE; de-binding the first, second, and third layers; and co-sintering the first, second, and third layers, where a CTE gap between the first CTE and the second CTE is between 10×10⁻⁷/° C. and 30×10⁻⁷/° C.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1A is a cross-sectional schematic view of a layered glass structure, according to an example of the present disclosure;

FIG. 1B is a cross-sectional schematic view of a layered glass structure with compressive and tensile stresses illustrated, according to an example of the present disclosure;

FIG. 2 is a side perspective view of a layered glass structure with an inner core layer and an outer shell layer, according to an example of the present disclosure;

FIG. 3 is a cross-sectional schematic view of the layered glass structure of FIG. 1, according to an example of the present disclosure;

FIG. 4 is a side perspective schematic view of a layered glass structure, according to an example of the present disclosure;

FIG. 5A is illustrative of a printed layered glass structure, according to an example of the present disclosure;

FIG. 5B is illustrative of the printed layered glass structure of FIG. 5A after de-binding, according to an example of the present disclosure;

FIG. 5C is illustrative of the printed and de-binded layered glass structure of FIG. 5B after sintering, according to an example of the present disclosure;

FIG. 6 is a graph illustrating stress of a layered glass structure without additional fillers, according to an example of the present disclosure;

FIG. 7A is a cross-sectional schematic view of a single glass layer constructed of a first glass material, according to an example of the present disclosure;

FIG. 7B is a cross-sectional schematic view of a single glass layer constructed of a second glass material, according to an example of the present disclosure;

FIG. 7C is a cross-sectional schematic view of a three-layer glass structure without fillers, according to an example of the present disclosure;

FIG. 7D is a cross-sectional schematic view of a three-layer glass structure including an inner layer without a filler and outer layers having 10 weight % of a filler, according to an example of the present disclosure;

FIG. 7E is a cross-sectional schematic view of a three-layer glass structure including an inner layer having 5 weight % of a first filler and outer layers having 10 weight % of a second filler, according to an example of the present disclosure;

FIG. 7F is a cross-sectional schematic view of a three-layer glass structure including an inner layer without a filler and outer layers having 15 weight % of a filler, according to an example of the present disclosure;

FIG. 7G is a cross-sectional schematic view of a three-layer glass structure including an inner layer having 5 weight % of a first filler and outer layers having 15 weight % of a second filler, according to an example of the present disclosure;

FIG. 8 is a graph illustrating stress of a layered glass structure with additional fillers, according to an example of the present disclosure;

FIG. 9 is a graph illustrating Vicker's hardness measurements of single-layer and three-layer glass structures, according to an example of the present disclosure; and

FIG. 10 is a method of manufacturing a 3D printed layered glass structure, according to an example of the present disclosure.

### DETAILED DESCRIPTION OF THE PREFERRED EMBODIMENTS

Additional features and advantages will be set forth in the detailed description that follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The term “CTE,” as used herein, refers to the coefficient of thermal expansion of a glass material, element, or the like in the disclosure (e.g., a core glass layer) as averaged over a temperature range between about 20° C. and about 300° C. The terms “relatively low CTE” and “low CTE” are used interchangeably in the disclosure with regard to outer glass layers having a CTE that is lower than the CTE of the inner glass layer. Similarly, the terms “relatively high CTE” and “high CTE” are used interchangeably in the disclosure with regard to the inner glass layer having a CTE that is higher than the CTE of the outer glass layers.

The terms “mechanical strengthening” and “mechanically strengthened” are used in relation to the layered glass structure of the disclosure to mean a glass structure or glass laminate that has been formed by laminating a high CTE core or inner glass layer to low CTE clad or outer glass layers, thereby creating compressive stresses in the outer glass layers when the limit is cooled following lamination.

The terms “chemically strengthened” and “chemical strengthening,” as used in the present description, are intended to mean glass (e.g., an inner glass layer, an outer glass layer, etc.) that has been strengthened using an ion exchange process, as understood by those with ordinary skill in the field of the disclosure, to create compressive stresses in the surface region of the glass at one or more of its major surfaces and edges.

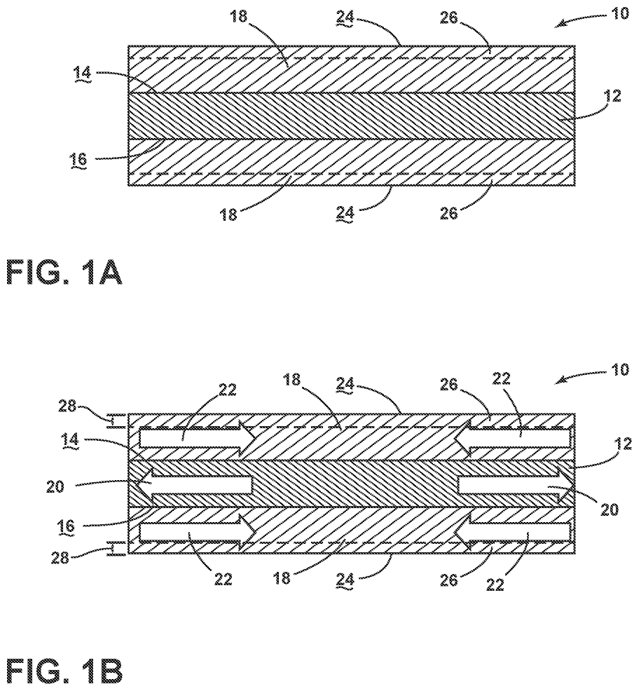

With reference to FIGS. 1A-10, reference numeral 10 generally designates a layered glass structure that includes an inner layer 12 having opposing major surfaces 14, 16. The inner layer 12 includes a first glass powder having a first powder coefficient of thermal expansion (CTE) and a first powder transition temperature (Tg). The inner layer 12 also includes a first inorganic filler. The inner layer 12 has a predefined ratio between the first glass powder and the first inorganic filler. The inner layer 12 has a first overall CTE higher than the first powder CTE the first overall Tg higher than the first powder Tg. The layered glass structure 10 also includes an outer layer 18 disposed on at least two opposing major surfaces 14, 16 of the inner layer 12. Each outer layer 18 includes a second glass powder having a second powder CTE and a second powder Tg. The outer layer 18 also includes a second inorganic filler. The outer layer 18 includes a predefined ratio between the second glass powder and the second inorganic filler. The second overall CTE is lower than the second powder CTE and lower than the first overall CTE. The second overall Tg is higher than the second powder Tg. A difference between the first overall Tg and the second overall Tg is less than 15° C.

Referring to FIGS. 1A and 1B, to mechanically strengthen the resulting layered glass structure 10 formed by the 3D printing process a CTE mismatch between layers 12, 18 of the glass structure 10 may be implemented. According to various examples, the glass structure 10 includes different compositional glasses, including a relatively high CTE inner glass layer 12 and a relatively low CTE outer glass layer 18 laminated to at least two of the major surfaces 14, 16 of the inner glass layer 12. Accordingly, the layered glass structure 10 forms a low-high-low CTE configuration. These relatively low CTE outer glass layers 18 can be laminated to the relatively high CTE inner glass layer 12 by bonding the surfaces of the glass layers together at elevated temperatures such that the outer glass layers fuse to the inner glass layer 12. The laminated glass structure 10 is then allowed to cool. As the laminated glass structure 10 cools, the relatively high CTE inner glass layer 12 contracts more than the relatively low CTE outer glass layers 18 that are securely bonded to the surfaces of the core glass layer. The high CTE inner layer 12 has a greater volume change relative to the low CTE outer layers 18.

Due to the variable contraction and volume change of the inner glass layer 12 and the outer glass layers 18 during cooling, the inner glass layer 12 is placed in a state of tension (or tensile stress), illustrated by arrows 20, and the outer glass layers 18 are placed in a state of compression (or compressive stress), illustrated by arrows 22, as best illustrated in FIG. 1B. The arrows 20, 22 represent the residual, in-plane stresses that are generated across the layers 12, 18.

The tensile stress 20 in the inner layer 12 and the compressive stress 22 in the outer layers 18 results in a mechanically strengthened glass structure 10 having a stress profile in which compressive stress (“CS”) extends from a primary surface 24 to a certain depth in each of the outer glass layers 18 or entirely through the outer glass layers 18. The compressive stresses 22 can be substantially uniformly distributed across the thicknesses of the outer layers 18. After the layered structure 10 is cooled during fabrication, the CTE difference between the inner layer 12 and the outer layers 18 causes an uneven volumetric contraction upon cooling, leading to the compressive stress region 26 below the primary surfaces 24. Maximizing the difference in CTE values between the inner layer 12 and the outer layers 18 can increase the magnitude of the compressive stress (CS) developed in the compressive stress regions 28 upon cooling of the layered structure 10 after fabrication.

The advantageous compressive stress region 26 (e.g., a CTE-related depth-of-compression, “DOC” 28) is thus formed in the layered glass structure 10. As used herein, the terms “depth of compression” and “DOC” refer to the depth at which the stress within the glass changes from compressive to tensile stress. At the DOC 28, the stress crosses from a positive (compressive) stress to a negative (tensile) stress and thus has a value of zero. The DOC 28 at the primary surface 24 of the outer glass layers 18 may be greater than 50 microns, greater than 100 microns, greater than 200 microns, greater than 300 microns, greater than 400 microns, greater than 500 microns, in a range between about 100 and 500microns, a range between about 200 and 300 microns, or other combinations of these ranges.

Compressive stresses (CS) at the primary surfaces 24 of the outer glass layers 18 may be over 5 MPa, over 10 MPa, over 25 MPa, over 50 MPa, over 250 MPa, between about 50MPa and about 700 MPa, between about 50 MPa and about 600 MPa, between about 50 MPa and about 500 MPa, between about 50 MPa and about 400 MPa, between about 50 MPa and about 300 MPa, from about 250 MPa about 600 MPa, between about 100 MPa and about 300MPa, and other values between these ranges, as the result of mechanical strengthening. Accordingly, the mechanical strength of the resulting glass structure 10 is improved by the compressive stress formed by the CTE mismatch.

Additionally, these compressive stresses can offset externally applied mechanical stresses, generally tensile stresses, (e.g., as applied through manufacturing-related handling, application-related loading, and other sources) to the primary surfaces 24, which have the net effect of strengthening the glass structure 10. The differences in CTE are also referred to herein as the CTE mismatch or CTE gap that generally form residual stress after the de-binding and sintering processing.

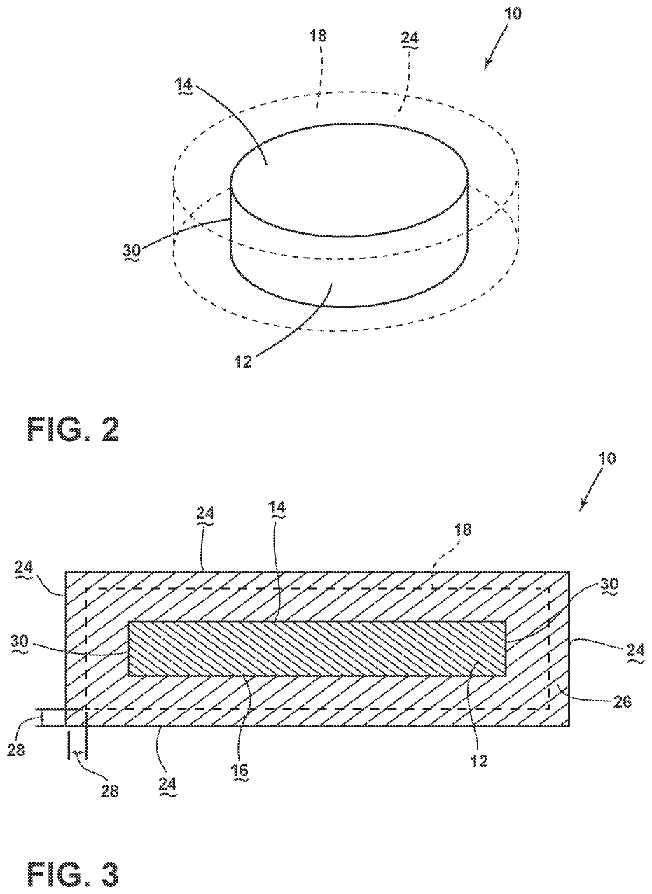

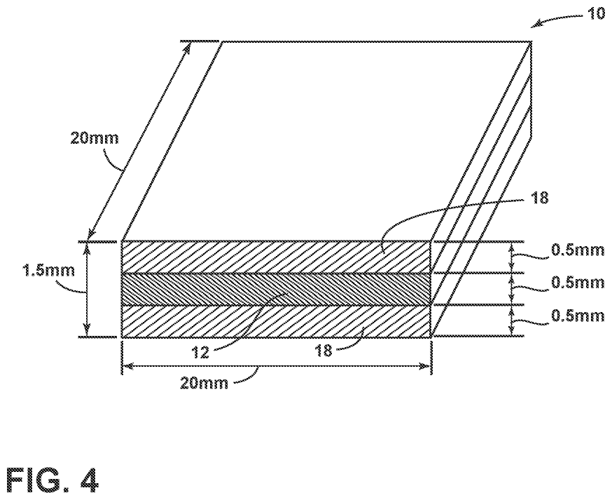

Referring to FIGS. 2 and 3, in an additional or alternative configuration, to mechanically strengthen an edge of the resulting layered glass structure 10 formed by the 3D printing process the CTE mismatch may also be implemented at the edge region of the layered glass structure 10. In such examples, the outer layer 18 covers the inner layer 12 on each surface 14, 16, 30. In the example illustrated in FIG. 2, the inner layer 12 has a substantially cylindrical shape including the opposing major surfaces 14, 16 with a single edge surface 30 extending therebetween. It is contemplated that the inner surface 12 may have a substantially cuboid or have a substantially rectangular prism shape including opposing major surfaces 14, 16 and opposing edge surfaces 30. The inner layer 12 may have a variety of shapes and the outer layer 18 may extend along each major surface 16, 18, each edge surface 30, and any other surface.

The outer layer 18 is a shell structure that extends around and surrounds the core or inner layer 12. Often, the edge of the layered glass structure 10 may be a weaker area compared to the primary surfaces 24. This weakness can be modified using the CTE mismatch when additional areas of the outer layer 18 extend along the edge of the glass structure 18. The CTE mismatch mechanically strengthens the edge of the layered glass structure 10 as the compressive stress (CS) extends from each primary surface 24 to form the compressive stress region 26 as described herein.

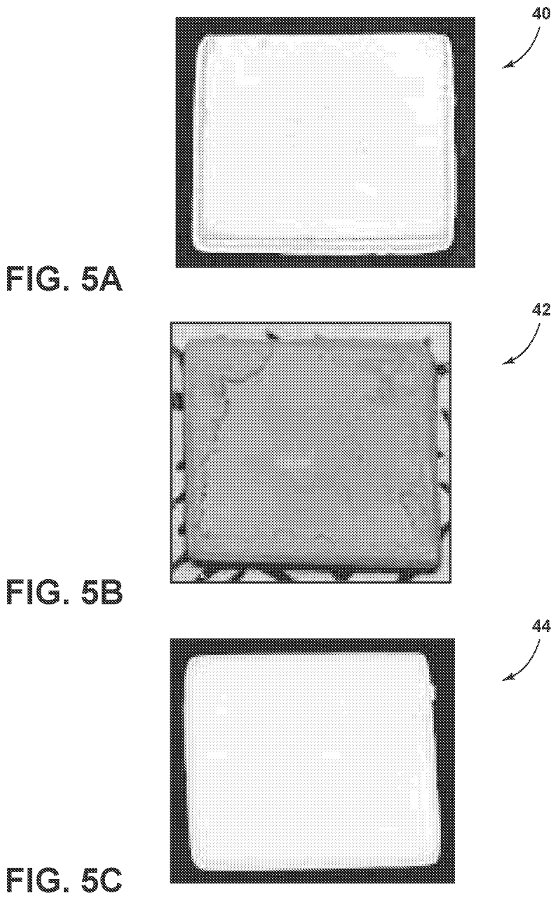

Referring to FIG. 4, the layered glass structure 10 disclosed herein is manufactured using an additive manufacturing or 3D printing process. The 3D printing process is utilized to form precise glass parts with high strength by controlling the thermal characteristics and compositional arrangement of the different compositional glasses. There are several types of 3D printing the can be utilized to make three-dimensional objects using glass materials, including, for example, photopolymerization (e.g., stereolithography or SLA, digital light processing or DLP), laser sintering (e.g., selective laser sintering or SLS), and nozzling (e.g., direct ink writing or DIW), as well as fused deposition modeling (FDM). The 3D printing process also includes post-processing steps, such as de-binding and sintering, which can cause a decline in the mechanical properties of the resulting structure. The use of 3D printing particularly photopolymerization, may allow the resulting glass structures 10 to retain original properties, such as transparency, heat resistance, and chemical resistance.

The 3D printing process includes various steps of modeling, printing, and finishing, which are utilized to form the resulting glass structure 10. Modeling may be a step of producing the 3D drawing, which uses a 3D computer aided design (CAD), a 3D modeling program, a 3D scanner, etc. During printing, the 3D drawing produced in the modeling step is created as a 3D object, and finishing generally supplements the output of the object (e.g., surface polishing, etc.). Three-dimensional printing is utilized for forming a three-dimensional structure 10 by laminating a two-dimensional structure layer by layer to form the three-dimensional shape by stacking layers of powder, for example of glass material.

Generally, a raw or source material is provided for the printing process. The source material may be at least one of the first glass powder and the second glass powder. The source material may also include at least one of the first inorganic filler and the second inorganic filler. The first glass powder is generally combined with the first inorganic filler, and the second glass powder is generally combined with the second inorganic filler. The inorganic fillers may be pre-combined with the glass powders, or alternatively may be provided to a printing assembly simultaneously with the glass powder to be combined.

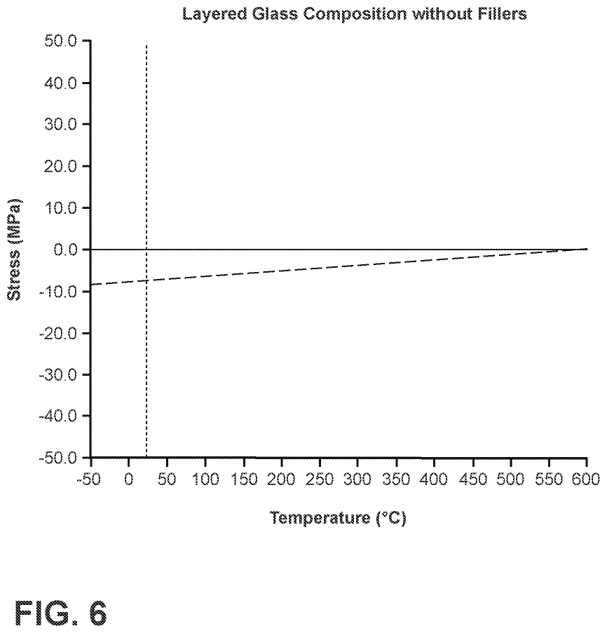

Referring still to FIG. 4, as well as to FIGS. 5A-5C, in a non-limiting example, the printing assembly includes a supply unit for storing the source materials and a transfer assembly to transfer the source materials to a printhead. The printhead includes an inlet in which the source materials are introduced. A heating element is configured to heat the source material within a melting furnace, and the heated source materials are temporarily stored within a nozzle. The nozzle then discharges the heated source materials into a work area. The work area provides a space in which the molten glass is discharged and molded into the selected shape while being sequentially stacked. A control unit is configured to independently control the printhead and the transfer of the source material to the printhead.

The printing assembly is configured to print the first layer (e.g., the first outer layer 18), the second layer (e.g., the inner layer 12) on the first layer, and the third layer (e.g., the second outer layer 18) on the second layer. The different source materials are supplied to the printhead to form the various layers of the select materials and size. Typically, the position of the printhead is adjusted to deposit the molten material in the select location to form the select glass structure 10. As disclosed herein, the resulting product is a printed three-dimensional layered structure 40 with the high CTE inner layer 12 and low CTE outer layers 18, as best illustrated in FIG. 5A.

Once the layers are printed to form the printed layered structure 40, the post-processing steps are conducted. During the printing process, organic binders are added to the source materials. These organic binders assist with the printing process, but can negatively impact the subsequent sintering process. Accordingly, during de-binding, these organic binders are removed from the printed structure 40. An example of a de-binded structure 42 is illustrated in FIG. 5B.

After de-binding, the resulting de-binded structure 42 is sintered to stabilize and form the sintered structure 44, as best illustrated in FIG. 5C. The organic binders affect the stabilization produced by the sintering process. The sintering temperature of glass compositions is generally higher than the de-binding temperature range of the resin to maintain the shape of the 3D stereoscopic structure and prevent internal gas trapping. The printed structure 40, the de-binded structure 42, and the sintered structure 44 are all various stages of the layered glass structure 10 during the printing process.

In certain aspects, the de-binding is performed at a temperature between about 500° C. and about 650° C. The de-binding process generally takes about 48 hours. Further, sintering may be conducted or performed at a temperature between about 800° C. and about 900° C., and more particularly in a range between about 840° C. and about 880° C. In the case of AE—aluminoborosilicate glass, the difference in CTE (α) is about 5.5×10^{-7/°} C., and the simultaneous sintering temperature may be in the range of 840° C. to 880° C. The sintering process generally takes about nine hours at a pressure of about 10⁻⁵ torr. Since a degreasing temperature range in the case of using acrylate-based resin is between about 500° C. and about 550° C., the sintering temperature of the low CTE glass composition and the high CTE glass composition is higher than the de-binding temperature range of the resin so that the shape of the 3D structure 10 remains intact. Deformation and delamination of multilayer glass structure 10 can be controlled through the compositional selection and residual stress calculation.

Referring still to FIGS. 4-5C, in a non-limiting example, a sample layered structure 10 was printed using the first and second glass powders without the first and second glass fillers to evaluate the mechanical properties of the printed multilayer glass structure 10. The three-layer glass structure 10 had a dimension of 20 mm×20 mm×1.5 mm, as illustrated in FIG. 4. The compressive residual stresses were induced in the outer layers 18 of the three-layer glass structure 10 due to a thermal mismatch between outer and inner layer materials. The level of residual stress depends on the elastic modulus, CTE, and thickness of each layer 12, 18. At the strain point of 574° C., the stress is about zero, but as the glass structure 10 cools down to room temperature, compressive stress develops that is proportional to the temperature difference differential. The arrangement of the glass composition (e.g., low-high-low) provides for the construction of a glass-based three-dimensional structure 10 with high mechanical strength, modulus, and select properties, such as scratch and acid resistance. Low CTE and high CTE glass compositions used for forming the 3D structure 10 have a CTE gap, which can form residual stress after lamination and sintering. The CTE gap is between about 5×10⁻⁷/° C. and about 15×10⁻⁷/° C.

The first glass powder having the high CTE may be referred to herein as Gorilla® Glass 2 or abbreviated as GG2. The second glass powder having the low CTE may be referred to herein as Gorilla® Glass 3 or abbreviated as GG3. Select physical properties of GG2 and GG3, respectively, without the first or second inorganic fillers described herein, are set forth in Table 1 below.

TABLE 1
Physical Properties of Glass Materials

| | | |
|---|---|---|
| Property | GG2 | GG3 |

| | | | | |
|---|---|---|---|---|
| Softening Point | 895° | C. | 900° | C. |
| Strain Point | 653° | C. | 628° | C. |
| Annealing Point | 599° | C. | 574° | C. |

| | | |
|---|---|---|
| Thermal Expansion | 8.14 × 10⁻⁷/° C. | 75.8 × 10⁻⁷/° C. |
| Coefficient (CTE) | | |

| | | | | |
|---|---|---|---|---|
| Density | 2.42 | g/cm³ | 2.39 | g/cm³ |
| Young's Modulus | 71.5 | GPa | 69.3 | GPa |

The nominal chemical compositions of GG2 and GG3, respectively, are set forth in Table 2 below.

TABLE 2
Chemical Properties of Glass Materials

| | |
|---|---|
| Components | Glass Composition |

| (mol. %) | GG2 | GG3 |
|---|---|---|
| SiO₂ | 68.96 | 67.55 |
| B₂O₃ | 0 | 3.67 |
| Al₂O₃ | 10.28 | 12.67 |
| Na₂O | 15.21 | 13.66 |
| K₂O | 0.012 | 0.014 |
| MgO | 5.37 | 2.33 |
| CaO | 0 | 0 |
| Fe₂O₃ | 0 | 0.008 |
| ZrO₂ | 0 | 0.005 |
| SnO₂ | 0.17 | 0.10 |

To form the printing paste to make the exemplary glass structure 10 having the GG2 inner layer 12 and the GG3 outer layers 18, the printing paste was manufactured by fixing the selected glass powder (e.g., GG2 or GG3), an ultraviolet (UV) resin, and a photoinitiator. To implement the multilayer glass structure 10 with photopolymer 3D printing, the photopolymerizable fluids or pastes for printing was manufactured with the compositions illustrated in Table 3 below.

TABLE 3
Composition of Photocompatible Pastes

| Component | GG2 (wt. %) | GG3 (wt. %) |
|---|---|---|
| Mono/Polymer | 8.68 | 8.71 |
| Dispersant | 6.52 | 6.58 |
| Modifiers | 13.92 | 13.98 |
| Photoinitiator | 0.97 | 0.75 |
| Filler/Particles | 69.91 | 69.63 |
| Color Agent | — | 0.35 |
| Total | 100 | 100 |

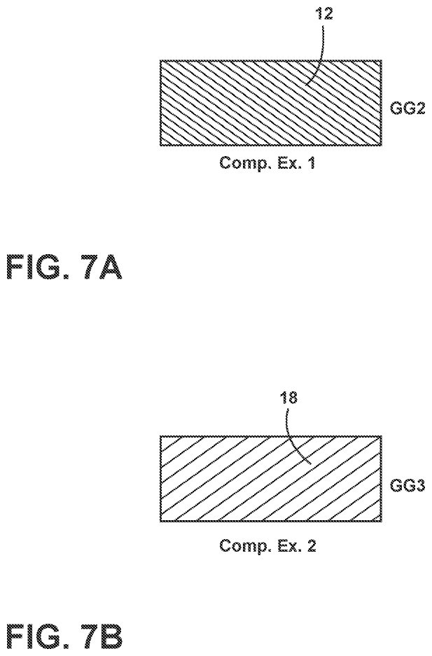

To distinguish between layers, 0.35 wt. % of chromium (III) nitrate was added to the paste of the GG3composition to indicate a green color. The manufactured pastes were produced by 48 hours of mixing (using IKA RW-20 stirrer). For 3D printing, a DLP 3D printer, Carima model IM-2 available from Carima Co. Ltd. of Seoul, South Korea was used, and the layer thickness was 50 μm. Further, de-binding occurred at 550° C. for 48 hours and sintering occurred at 820° C. at a pressure of 10⁻⁵ torr for nine hours. For the example structure 10 having the inner layer 12 with the first glass powder and the outer layers 18 having the second glass powders and each layer having the same thickness (about 1.5 mm), the compressive stress of about −7.3 mPA at 23° C. can be estimated, as illustrated in FIG. 6.

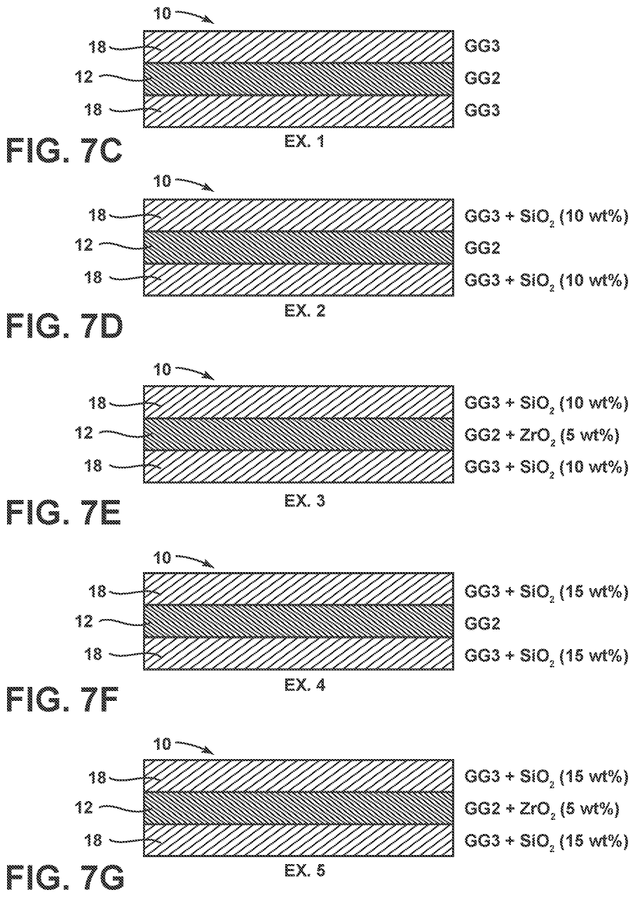

Referring to FIGS. 7A7G, to increase mechanical properties of the layered glass structure 10, a greater CTE mismatch is advantageous. However, as the CTE mismatch is increased, the difference in sintering temperatures for the layers also increases. CTE is a thermal property and thermal properties depend on glass composition. Larger ranges between the CTE result in larger residual compressive stress but can cause a larger range of thermal properties, such as strain and softening temperatures. The sintering temperature is generally located between the strain and softening temperatures, leading to difficulty in simultaneously co-sintering the layers 12, 18 in the layered glass structure 10.

The addition of the inorganic fillers assists in controlling the CTE mismatch between the inner layer 12 and the outer layers 18, as well as control the Tg to allow for co-sintering. The glass transition temperature or Tg is the temperature at which the glass transitions from a rigid state to a more flexible state making the temperature at the border of a solid state and a rubbery state. It is advantageous to have closer transition temperatures to simultaneously co-sinter the layers 12, 18 into the final layered glass structure 10.

### EXAMPLES

The following examples describe various features and advantages provided by the disclosure, and are in no way intended to limit the invention and appended claims. Five example structures 10 were created using the printing process disclosed herein.

Each Example was formed by creating a three-layer structure 10 with the low CTE inner layer 12 and the high CTE outer layers 18. Multiple mixtures of the GG3 glass powder with and without the SiO₂ inorganic filler were utilized for the outer layers 18. Additionally, multiple mixtures of the GG2 glass powder with and without the ZrO₂ inorganic filler were utilized for the inner layer 12. The composition of the different mixtures and the thermal properties thereof are set forth in Table 4 below.

TABLE 4
Thermal Properties of Glass Mixtures

| | | Glass Powder | | | Filler | | | Measured Results | |
|---|---|---|---|---|---|---|---|---|---|
| | Mixing | | PSD | CTE | | PSD | CTE | | CTE |
| | Ratio | | (D50, | (10⁻⁷/° | | (D50, | (10⁻⁷/° | | (10⁻⁷/° |
| Mixture | (Glass:Filler) | Composition | μm) | C.) | Composition | μm) | C.) | Tg | C.) |
| Mix. A | 100 | GG3 | 2.5 | 75.8 | — | — | — | 667 | 75.97 |
| Mix. B | 95:5 | GG3 | 2.5 | 75.8 | SiO₂ | 0.04 | 5.5 | 675 | 74.2 |
| Mix. C | 90:10 | GG3 | 2.5 | 75.8 | SiO₂ | 0.04 | 5.5 | 674 | 70.03 |
| Mix. D | 85:15 | GG3 | 2.5 | 75.8 | SiO₂ | 0.04 | 5.5 | 682 | 61.78 |
| Mix. E | 100 | GG2 | 2.5 | 81.4 | — | — | — | 680 | 87.11 |
| Mix. F | 95:05 | GG2 | 2.5 | 81.4 | ZrO₂ | 1.4 | 105 | 682 | 89.43 |
| Mix. G | 90:10 | GG2 | 2.5 | 81.4 | ZrO₂ | 1.4 | 105 | 684 | 85.21 |

For the outer layers 18, four examples (Examples A-D) were created using one of the Mixtures A-D, having different ratios between the GG3 glass powder and the SiO₂. For the inner layer 12, three examples (Examples E-G) were created using one of the Mixtures E-G, having different ratios between the GG2 glass powder and the ZrO₂. The use of the inorganic fillers altered the CTE of the resulting layers 12, 18 compared to the glass powders, respectively.

### Example 1

Example 1 is constructed of the GG2 inner layer 12 (Mixture E) and the GG3 outer layers 18 (Mixture A), without the inorganic fillers. Example 1 is a three-layered structure with the CTE mismatch. The GG2 glass powder used as the source material has a CTE of 81.4×10⁻⁷/° C., and the layer constructed of the GG2 glass powder has a CTE of 87.11×10⁻⁷/° C. and a Tg of 680° C. The GG3 glass powder used as the source material has a CTE of 75.8×10⁻⁷/° C., and the layer constructed of the GG3 glass powder has a CTE of 75.97×10⁻⁷/° C. and a Tg of 667° C. Accordingly, Example 1 has a CTE mismatch of 11.14×10⁻⁷/° C. and a Tg difference of 13° C.

### Examples 2-5

In comparison to Example 1, Examples 2-5 each include at least one of the first inorganic filler and the second inorganic filler. The first inorganic filler is utilized in various combinations with the GG2 glass powder. The first inorganic filler is at least one of ZrO₂ (stabilized) and K₂O—Al₂O₃—2SiO₂. ZrO₂ has a CTE of 105×10⁻⁷/° C., higher than the CTE of the GG2 glass powder. The source material for the low CTE layer 18 generally has a predefined ratio between the GG2 glass powder and the first inorganic filler. With the various combinations, the layered glass structure 10 may include between about 90 wt. % and about 95 wt. % of the GG2 glass powder and between about 5 wt. % and 10 wt. % of the first inorganic filler in the inner layer 12. In certain aspects, the predefined ratio is at least one of 95:05 and 90:10 (e.g., GG2: ZrO₂). Overall, the first inorganic filler slightly increases the Tg of the inner layer 12.

The second inorganic filler is utilized in various combinations with the GG3 glass powder. The second inorganic filler is at least one of SiO₂, Zr₂(WO₄)(PO₄)₂, and Zr₂O (PO₄)₂. SiO₂ has a CTE of 5.5×10⁻⁷/° C., which is lower than the CTE of the GG3 glass powder. The source material for the high CTE layer has a predefined ratio between the GG3 glass powder and the second inorganic filler. With the various combinations, the layered glass structure 10 may include between about 85 wt. % and about 95 wt. % of GG3 glass powder and between about 5 wt. % and about 10 wt. % of the second inorganic filler in the outer layers 18. In certain aspects, the predefined ratio is at least one of 95:05, 90:10, and 85:15 (e.g., GG3:SiO₂). Overall, the second inorganic filler lowers the CTE and increases the Tg of the layers 18.

### Example 2

Example 2 includes the inner layer 12 of GG2 glass without the first inorganic filler (Mixture E) and the outer layers 18 having a ratio of 90:10 between the GG3 glass powder and SiO₂ (Mixture C). The outer layers 18 have an increased Tg and a lowered CTE relative to the pure GG3 layer. In this example, the outer layers 18 have a Tg of 675° C. and a CTE of 74.2×10⁻⁷/° C. This creates a CTE mismatch of 17.08×10⁻⁷/° C. and a difference in Tg of 5° C.

### Example 3

Example 3 includes the inner layer 12 having a ratio of 95:05 of the GG2 glass powder and ZrO₂ (Mixture F). The inner layer 12 has a CTE of 89.43×10⁻⁷/° C. and a Tg of 682° C., which are both higher than the layer of pure GG3. The outer layers 18 have a ratio of 90:10 between the GG3 glass powder and the SiO₂ (Mixture C). Example 3 has a CTE mismatch of 19.4×10⁻⁷/° C. and a difference in Tg of 8° C. The CTE mismatch is increased from Example 2 without significantly changing the difference in Tg.

Example 4

Example 4 includes the inner layer 12 having the GG2 glass powder without the first inorganic filler (Mixture E). Example 4 also includes the outer layers 18 having a ratio of 85:15 between the GG3 glass powder and SiO₂ (Mixture D). The outer layers 18 have a CTE of 61.78 and a Tg of 682° C. This configuration of the layered structure 10 has a CTE mismatch of 17.08×10⁻⁷/° C. and a difference in Tg of 2° C.

Example 5

Example 5 includes the inner layer 12 having a ratio of 95:05 of the GG2 glass powder and ZrO₂ (Mixture F). The inner layer 12 has a CTE of 89.43×10⁻⁷/° C. and a Tg of 682° C. The outer layers 18 have a ratio of 85:15 between the GG3 glass powder and SiO₂ (Mixture D). The outer layers 18 have a CTE of 61.78 and a Tg of 682° C. Example 5 has a CTE mismatch of 27.65, which is the highest of the Examples disclosed herein while having a difference in Tg of about 0° C. Example 5 has an increased CTE mismatch and eliminates the difference in Tg.

As best illustrated in Table 4, for the outer layer 18, when SiO₂ was added up to 15 wt. %, the CTE decreased by about 20%, and for the inner layer 12, when ZrO₂ was added at 5 wt. %, the CTE increased slightly. In addition, when the inorganic fillers were added, Tg generally increased to a similar temperature range. Since the Tg temperature range for simultaneous sintering is at most about 30° C., co-sintering is possible when the glass compositions shown in FIGS. 7A-7G are combined. Through this, the layered glass structure 10 is formed from a composition combination that maximizes the CTE mismatch effect and allows co-sintering.

Utilizing the inorganic fillers adjusts the Tg and the CTE of the resulting layers of the glass structure 10, and consequently affects the CTE mismatch and the difference in Tg of the layered glass structure 10. With the various combinations, the layered glass structure 10 may include between about 85 wt. % and about 95 wt. % of GG3 glass powder and between about 5 wt. % and about 10 wt. % of the second inorganic filler in the outer layers 18 and between about 90 wt. % and about 95 wt. % of the GG2 glass powder and between about 5 wt. % and 10 wt. % of the first inorganic filler.

These combinations of layers provide a CTE mismatch and a decrease in the difference between the Tg of the inner layer 12 and the Tg of the outer layer 18. Further, the inner layer 12 may have a different CTE than the first glass powder (e.g., a first powder CTE). Additionally, the CTE of the inner layer 12 with the first inorganic filler and without the first inorganic filler may be different. Also, the Tg of the inner layer 12 with the first inorganic filler may be different than the Tg of the layer without the first inorganic filler (e.g, a first powder Tg). Similarly, the outer layer 18 may have a different CTE compared to the second glass powder (e.g., a second powder CTE). The CTE of the outer layer 18 with the second inorganic filler and without the second inorganic filler may be different. Additionally, the Tg of the outer layer 18 with the second inorganic filler may be different than the Tg of the layer without the second inorganic filler (e.g., a second powder Tg). Accordingly, the thermal properties of the inner layer 12 and the outer layer 18 may be adjusted by the addition of the inorganic fillers and/or the amount of the inorganic fillers added.

With these combinations, and the change in CTE with the inorganic filler, the GTE gap may be increased through the use of the inorganic fillers and the layered arrangement. The CTE Gap for Examples 1-5 are shown below in Table 5.

TABLE 5
Printing Examples of CTE Mismatched 3-Layer Structures and CTE Gap Values

| | | | | CTE Gap |
|---|---|---|---|---|
| Example No. | Low CTE Part | High CTE Part | Low CTE Part | (10⁻⁷/° C.) |
| Ex. 1 | Mixture A: GG3 | Mixture D: GG2 | Mixture A: GG3 | 11.14 |
| Ex. 2 | Mixture C: GG3 | Mixture D: GG2 | Mixture C: GG3 | 17.08 |
| | (90 wt. %) + | | (90 wt. %) + | |
| | SiO₂ (10 wt. %) | | SiO₂ (10 wt. %) | |
| Ex. 3 | Mixture C: GG3 | Mixture E: GG2 | Mixture C: GG3 | 19.40 |
| | (90 wt. %) + | (95 wt. %) + | (90 wt. %) + | |
| | SiO₂ (10 wt. %) | ZrO₂ (5 wt. %) | SiO₂ (10 wt. %) | |
| Ex. 4 | Mixture D: GG3 | Mixture D: GG2 | Mixture D: GG3 | 17.08 |
| | (85 wt. %) + | | (85 wt. %) + | |
| | SiO₂ (15 wt. %) | | SiO₂ (15 wt. %) | |
| Ex. 5 | Mixture D: GG3 | Mixture E: GG2 | Mixture D: GG3 | 27.65 |
| | (85 wt. %) + | (95 wt. %) + | (85 wt. %) + | |
| | SiO₂ (15 wt. %) | ZrO₂ (5 wt. %) | SiO₂ (15 wt. %) | |

As illustrated in the above tables, the layered glass structure 10 may have a CTE gap between about 10×10⁻⁷/° C. and about 30×10⁻⁷/° C., and more particularly between about 15×10⁻⁷/° C. and about 30×10⁻⁷/° C. In regards to the high CTE layer 12, the high CTE layer 12 may have a CTE in a range between about 85×10⁻⁷/° C. and about 90×10⁻⁷/° C. A difference between the overall CTE of the inner layer 12 and the CTE of the GG2 glass powder may be less than about 10×10⁻⁷/° C., or more particularly between about 4×10⁻⁷/° C. and about 10×10⁻⁷/° C. Further, a difference between the overall CTE of the inner layer 12 with the first inorganic filler and the CTE of the layer of GG2 without the first inorganic filler may be between about 1×10⁻⁷/° C. and about 3×10⁻⁷/° C.

Additionally, the outer layer 18 may have a CTE in a range between about 60×10⁻⁷/° C. and about 76×10⁻⁷/° C. A difference between the overall CTE of the outer layer 18 with the second inorganic filler and the CTE of the layer of GG3 without the second inorganic filler may be between about 2×10⁻⁷/° C. and about 15×10⁻⁷/° C. The CTE gap between the outer layer 18 and the CTE of the GG3 glass power is less than about 15×10⁻⁷/° C.

Further, with these combinations, the layered glass structure 10 may have a difference in the overall Tg of the inner layer 12 and the overall Tg of the outer layer 18 of about 10° C. or less. A difference between the overall Tg of the inner layer 12 with the first inorganic filler compared to the Tg of the GG2 layer without the first inorganic filler may be between about 5° C. and about 20° C., and more particularly between about 7° C. and about 15° C. Also, a difference between the overall Tg of the outer layer 18 with the second inorganic filler compared to the Tg of the GG3 layer without the second inorganic filler may be between less than about 5° C., and more particularly between about 2° C. and about 4° C.

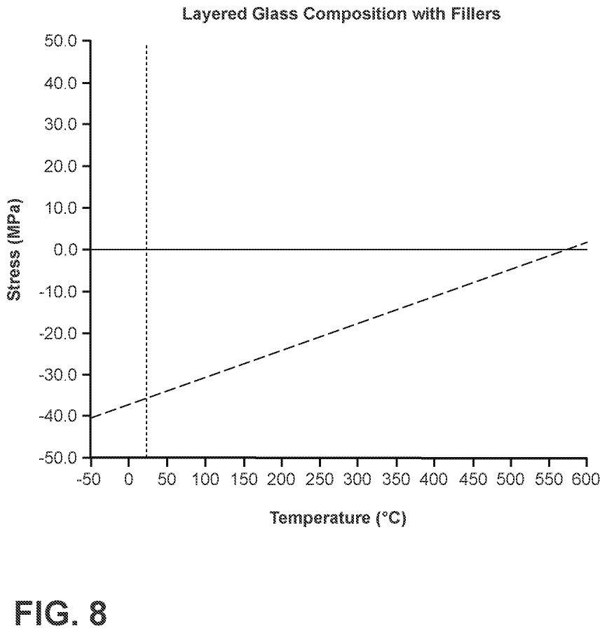

Referring again to FIG. 6, as well as to FIG. 8, a comparison of the residual stress calculation between a three-layered structure 10 without inorganic fillers (e.g., Example 1) and a three-layered structure 10 with at least one of the inorganic fillers (e.g., Examples 2-5) is illustrated. For Example 1, having three layers and without the added inorganic fillers, the compressive stress is about −7.3 MPa at 23° C. (as best illustrated in FIG. 6). When the inorganic fillers were applied to both the inner and outer layers 12, 18, as in the Examples 3 and 5, the residual compressive stress increased by about 5 times at 23° C. relative to the glass structure 10 without the fillers (Example 1). The graph illustrated in FIG. 8 is the average compressive stress that results from applying the inorganic filler to GG2 and GG3, respectively (e.g., Example 3 and Example 5).

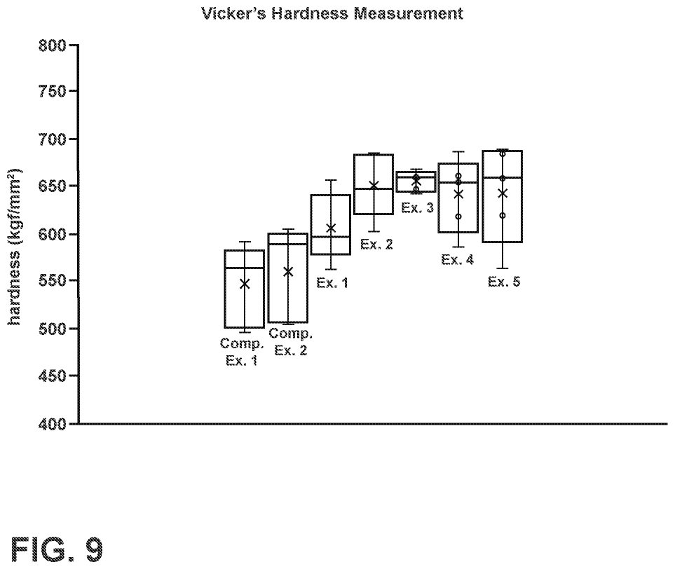

Referring to FIG. 9, mechanical properties of Examples 1-5 were compared with one another as well as reference samples, including Comparative Example 1 and Comparative Example 2. Comparative Example 1 is a single layer constructed of GG2 without the filler (as illustrated in FIG. 7A), and Comparative Example 2 is a single layer constructed of GG3 without the filler (as illustrated in FIG. 7B).

To evaluate mechanical properties of the Comparative Examples 1-2 and Examples 1-5, the Vicker's hardness of single layer (Comparative Example 1 and 2) and three-layer structure 10 samples (Examples 1-5) were measured on the ASTM C1327-15 indentation test The measured hardness values are set forth in Table 6 below.

TABLE 6
Vicker's Hardness Measurement

| Example | Sample | Mean (kgf/mm²) | SD |
|---|---|---|---|
| Comp. Ex. 1 | 1 Layer (Mix. E) | 546.2 | 41.4 |
| Comp. Ex. 2 | 1 Layer (Mix. A) | 560.6 | 49.1 |
| Ex. 1 | 3 Layer (Mix. E-Mix. | 606.6 | 35.1 |
| | A-Mix. E) | | |
| Ex. 2 | 3 Layer (Mix. C-Mix. | 650.5 | 33.2 |
| | E-Mix. C) | | |
| Ex. 3 | 3 Layer (Mix. C-Mix. | 655.1 | 10.6 |
| | F-Mix. C) | | |
| Ex. 4 | 3 Layer (Mix. D-Mix | 640.8 | 39.2 |
| | E-Mix. D) | | |
| Ex. 5 | 3 Layer (Mix. D-Mix. | 643.0 | 52.6 |
| | F-Mix. D) | | |

Comparative Examples 1 and 2 include a single layer of glass materials, and therefore do not have increased mechanical strength from a CTE mismatch. Further, the Comparative Examples do not include the inorganic fillers to adjust the CTE and the Tg. Comparative Example 1 showed an average hardness of 546.2 kgf/mm², and Comparative Example 2showed a hardness of 560.6 kgf/mm².

In comparison, Examples 1-5 having three-layered structure exhibited an increased hardness (e.g., mechanical properties) relative to Comparative Example 1 and Comparative Example 2. Overall, the layered glass structure 10 shows a hardness between about 600 kgf/mm² and about 660 kgf/mm², which is between about 50 kgf/mm² and about 100 kgf/mm² above the Comparative Examples. When the original GG2 and GG3 glass were combined, and without the addition of either of the inorganic fillers, the hardness increased by about 10%. Example 1 showed an increased harness of 606.6 kgf/mm².

The hardness exhibited by Example 2-5 having at least one of the inorganic fillers was increased further relative to the Comparative Examples 1 and 2. In the case of applying at least one of the inorganic fillers (Examples 2-5), regardless of the type and amount of the filler, almost 20% of a hardness increase effect was observed. The layered structure 10 with at least one inorganic filler shows a hardness between 640 kgf/mm² and 660 kgf/mm². This hardness increase may be equivalent to chemical strengthening through an ion exchange process, without conducting the ion exchange process and without the material limitations of the ion exchange process.

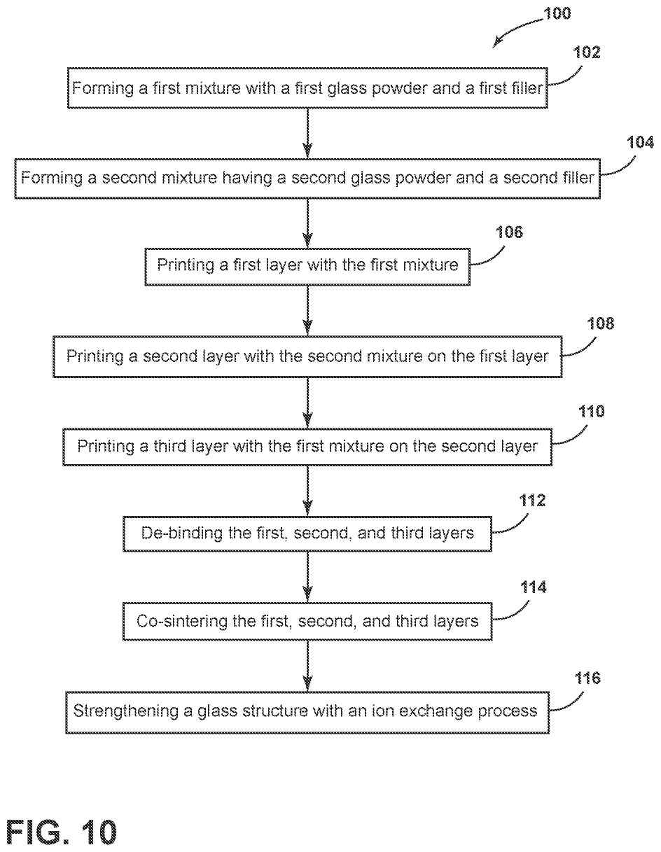

Referring to FIG. 10, as well as to FIGS. 1A-9, a method 100 for manufacturing the layered glass structure 10 includes step 102 forming a low CTE mixture having the GG3 glass powder and the inorganic filler. The GG3 glass powder and the inorganic filler, which is at least one of SiO₂, Zr₂(WO₄)(PO₄)₂, and Zr₂O(PO₄)₂, are combined in a predefined ratio to form the first mixture. The first mixture produces the low CTE outer layer 18. In step 104, a high CTE mixture is formed having the GG2 glass powder and the inorganic filler. The GG2 glass powder and the inorganic filler, which is at least one of ZrO₂ and K₂O—Al₂O₃—2SiO₂, are combined in a predefined ratio to form the second mixture. The second mixture produces the high CTE inner layer 12. The first low CTE mixture and the second high CTE mixture are the source materials supplied to the printing assembly.

In step 106, the first outer layer 18 is printed using the low CTE mixture. The low CTE mixture is deposited in the work area having the select dimensions, generally programmed or selected by a user. In step 108, the inner layer 12 is printed on the first outer layer 18. The inner layer 12 includes the high CTE mixture. In step 110, the second outer layer 18 is printed on the inner layer 12. The second outer layer 18 includes the low CTE mixture. Accordingly, the layers are printed in the low-high-low CTE pattern. It is contemplated that printing the outer layers 18 may form the three-layer stacked structure, as illustrated in FIG. 4 or may form the shell structure that surrounds the core, as illustrated in FIG. 2.

After the printing is complete, the printed structure 40 is de-binded in step 112. Each of the previously printed layers is de-binded to remove the organic binders used during the printing process. The de-binding is generally performed at a temperature in a range between about 500° C. and about 650° C. The de-binding takes a predefined period of time, which may be about 48 hours. The de-binded structure 42, including all three-layers, is then co-sintered simultaneously in step 114. The simultaneous co-sintering is generally performed at a temperature in a range between about 840° C. and 880° C. The co-sintering is also generally performed at a pressure of about 10⁻⁵ torr. Further, the co-sintering takes a predefined period of time, which may be about nine hours. This simultaneous co-sintering may be accomplished through the lower difference in Tg controlled by the inorganic fillers in the first mixture, the second mixture, or a combination thereof. After sintering, a mechanically strengthened layered glass structure 10 is produced.

In various examples, the mechanically strengthened glass structure 10 may also be chemically strengthened through an ion exchange process in step 116. The outer glass layers 18 can be configured with a compressive stress region generated from an ion-exchange process. The outer layer 18 can also be configured with an ion-exchangeable glass composition (e.g., a glass composition with one or more alkali metal ions, some of which may be exchanged with other alkali metal ions to develop residual compressive stresses). That is, the outer glass layers 18 may be configured with a compressive stress region to chemically strengthen the glass structure 10 by virtue of the development of compressive stress in surface regions of the outer glass layers 18.

More particularly, a compressive stress region is developed in the outer glass layers 18 such that compressive stress is present at the surface of the outer glass layers 18 and through a portion of the outer glass layers 18 to a particular depth. It should also be understood that the compressive stresses developed through chemical strengthening (e.g., an ion-exchange process) can be in addition to existing residual compressive stresses possessed by the outer glass layers 18 from mechanical strengthening (e.g., via the CTE mismatch between the outer glass layers 18 and the inner glass layer 12). Accordingly, the compressive stress created at the primary surfaces 24 and near surface regions of the plurality of outer glass layers 18 from the CTE mismatch can be comparable to or greater than what can otherwise be achieved by a chemical strengthening process alone.

Further, the ion exchange process provides additional strengthening to the layered structure 10. The ion exchange process may form compressive stress regions in each outer layer 18 with a compressive stress (CS) of 200 MPa or greater, 300 MPa or greater, 400 MPa or greater, 500 MPa or greater, 600 MPa or greater, 700 MPa or greater, 800 MPa or greater, 900 MPa or greater, a range between 200 MPa and about 1000 MPa, or between about 200MPa and about 800 MPa. The ion exchange process may cause compressive stress between about 50 microns and about 200 microns from the primary surface 24 of the outer layers 18, which is considered generally shallow. The compressive stress (CS) may extend from the primary surface 24 of each outer layer 18 to a certain depth (e.g., depth-of-layer, “DOL”), which is less than the DOC 28 of the compressive stress region 28 formed from the CTE mismatch. The CTE mismatch provides deeper compressive stress in the layered glass structure 10. The combination then produces a layered structure 10 that has both shallow and deep compressive stress. With both strengthening processes, the compressive stress at the primary surface 24 of the outer layers 18 may be as high as between about 700 MPa and about 1000 MPa.

Use of the present structures 10 and system provide for a variety of advantages. For example, the layered glass structure 10 is manufactured using 3D printing processes. These 3D printing processes allow the glass structure 10 to retain its original properties, such as transparency, heat resistance, and chemical resistance. Further, the layered glass structure 10 has the CTE mismatch, which mechanically strengthens the layered structure 10, as evidenced by the increase in the Vicker's hardness measurements. Additionally, the layered glass structure 10 has an increased CTE mismatch and a decrease in the difference of the Tg between the layers 12, 18 by using the inorganic fillers. Also, the decrease in the difference in Tg allows the increased CTE mismatch and allows for co-sintering the layers together. Also, the layered structure 10 may not have the compositional limitations for chemical strengthening. Further, the use of the 3D printing process may reduce material and machining tool costs. Moreover, the sintering temperature for the 3D printed structure 10 may be lower compared to ceramics, which may be beneficial for quick prototyping and testing of designs. Additional benefits and advantages may be realized and/or achieved.

According to a first aspect of the present disclosure, a layered glass structure includes an inner layer having opposing major surfaces and includes a first glass powder having a first powder coefficient of thermal expansion (CTE) and a first powder transition temperature (Tg). The inner layer includes a first inorganic filler. The inner layer includes a predefined ratio between the first glass powder and the first inorganic filler. The inner layer has a first overall CTE higher than the first powder CTE and a first overall Tg higher than the first powder Tg. An outer layer is disposed on each opposing major surface of the inner layer. The outer layer includes a second glass powder having a second powder CTE and a second powder Tg. The outer layer includes a second inorganic filler. The outer layer includes a predefined ratio between the second glass powder and the second inorganic filler. The outer layer has a second overall CTE lower than the second powder CTE and lower than the first overall CTE and a second overall Tg higher than the second powder Tg. A difference between the first overall Tg and the second overall Tg is less than 15° C.

According to a second aspect of the present disclosure, a CTE gap between a first overall CTE and a second overall CTE is between 10×10⁻⁷/° C. and 30×10⁻⁷/° C.

According to a third aspect of the present disclosure, a first inorganic filler is at least one of ZrO₂ and K₂O—Al₂O₃—2SiO₂, and a second inorganic filler is at least one of SiO₂, Zr₂(WO₄)(PO₄)₂, and Zr₂O(PO₄)₂.

According to a fourth aspect of the present disclosure, an outer layer covers all surfaces of an inner layer.

According to a fifth aspect of the present disclosure, a predefined ratio includes between 90 wt. % and 95 wt. % of a first glass powder and between 5 wt. % and 10 wt. % of a first inorganic filler. A predefined ratio includes between 85 wt. % and 95 wt. % of a second glass powder and between 5 wt. % and 15 wt. % of a second inorganic filler.

According to a sixth aspect of the present disclosure, a CTE gap between a second powder CTE and a second overall CTE is less than 15×10⁻⁷/° C.

According to a seventh aspect of the present disclosure, a CTE gap between a first powder CTE and a first overall CTE is less than 10×10⁻⁷/° C.

According to an eighth aspect of the present disclosure, a layered glass structure includes an inner layer having opposing major surfaces. The inner layer includes a first glass powder and a first inorganic filler. The inner layer has a first coefficient of thermal expansion (CTE) and a first transition temperature (Tg). An outer layer is disposed on each opposing major surface of the inner layer. The outer layer includes a second glass powder and a second inorganic filler. The outer layer has a second CTE and a second Tg. A CTE gap between the first CTE and the second CTE is between 10×10⁻⁷/° C. and 30×10⁻⁷/° C. A difference between the first Tg and the second Tg is 10° C. or less.

According to a ninth aspect of the present disclosure, a second inorganic filler is SiO₂ and is between 5 wt. % and 15 wt. % of a composition of an outer layer.

According to a tenth aspect of the present disclosure, a first inorganic filler is ZrO₂ and is between 5 wt. % and 10 wt. % of a composition of an inner layer.

According to an eleventh aspect of the present disclosure, a glass structure has a hardness between 600 kgf/mm² and 660 kgf/mm².

According to a twelfth aspect of the present disclosure, a second inorganic filler is SiO₂ and is 15 wt. % of a composition of an outer layer, and a first inorganic filler is ZrO₂ and is 5 wt. % of a composition of an inner layer.

According to a thirteenth aspect of the present disclosure, a first CTE of an inner layer is between 85×10⁻⁷/° C. and 90×10⁻⁷/° C., and a second CTE of an outer layer is between 60×10⁻⁷/° C. and 75×10⁻⁷/° C.

According to a fourteenth aspect of the present disclosure, a first Tg equals a second Tg.

According to a fifteenth aspect of the present disclosure, a method of manufacturing a layered glass structure includes forming a first mixture having a predefined ratio of a first glass powder and a first inorganic filler; forming a second mixture having a predefined ratio of a second glass powder and a second inorganic filler; printing a first layer including the first mixture, where the first layer has a first transition temperature (Tg) and a first coefficient of thermal expansion (CTE) lower than a CTE of the first glass powder; printing a second layer comprising the second mixture on the first layer, the second layer having a second Tg and a second CTE higher than a CTE of the second glass powder and higher than the first CTE; printing a third layer including the first mixture on the second layer, where the third layer has the first CTE; de-binding the first, second, and third layers; and co-sintering the first, second, and third layers, where a CTE gap between the first CTE and the second CTE is between 10×10⁻⁷/° C. and 30×10⁻⁷/° C.

According to a sixteenth aspect of the present disclosure, a method includes strengthening a glass structure with an ion exchange process.

According to a seventeenth aspect of the present disclosure, a first inorganic filler is ZrO₂ and a second inorganic filler is SiO₂.

According to an eighteenth aspect of the present disclosure, a step of co-sintering is performed at a temperature between 840° C. and 880° C. and at a pressure of 10⁻⁵ torr.

According to a nineteenth aspect of the present disclosure, a difference between a first Tg of first and third layers and a second Tg of a second layer is 10° C. or less.

According to a twentieth aspect of the present disclosure, a step of de-binding is performed at a temperature between 500° C. and 650° C.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A layered glass structure, comprising:
an inner layer having opposing major surfaces and comprising:
a first glass powder having a first powder coefficient of thermal expansion (CTE) and a first powder transition temperature (Tg); and
a first inorganic filler, wherein the inner layer comprises a predefined ratio between the first glass powder and the first inorganic filler, and wherein the inner layer has a first overall CTE higher than the first powder CTE and a first overall Tg higher than the first powder Tg; and
an outer layer disposed on at least two opposing major surfaces of the inner layer, the outer layer comprising:
a second glass powder having a second powder CTE and a second powder Tg; and
a second inorganic filler, wherein the outer layer comprises a predefined ratio between the second glass powder and the second inorganic filler, and wherein the outer layer has a second overall CTE lower than the second powder CTE and lower than the first overall CTE and a second overall Tg higher than the second powder Tg, and further wherein a difference between the first overall Tg and the second overall Tg is less than 15° C.

2. The glass structure of claim 1, wherein a CTE gap between the first overall CTE and the second overall CTE is between 10×10⁻⁷/° C. and 30×10⁻⁷/° C.

3. The glass structure of claim 1, wherein the first inorganic filler is at least one of ZrO₂ and K₂O—Al₂O₃—2SiO₂ and the second inorganic filler is at least one of SiO₂, Zr₂(WO₄)(PO₄)₂, and Zr₂O(PO₄)₂.

4. The glass structure of claim 1, wherein the outer layer covers all surfaces of the inner layer.

5. The glass structure of claim 1, wherein the predefined ratio includes between 90 wt. % and 95 wt. % of the first glass powder and between 5 wt. % and 10 wt. % of the first inorganic filler, and wherein the predefined ratio includes between 85 wt. % and 95 wt. % of the second glass powder and between 5 wt. % and 15 wt. % of the second inorganic filler.

6. The glass structure of claim 1, wherein a CTE gap between the second powder CTE and the second overall CTE is less than 15×10⁻⁷/° C.

7. The glass structure of claim 1, wherein a CTE gap between the first powder CTE and the first overall CTE is less than 10×10⁻⁷/° C.

8. A layered glass structure, comprising:
an inner layer having opposing major surfaces comprising a first glass powder and a first inorganic filler, wherein the inner layer has a first coefficient of thermal expansion (CTE) and a first transition temperature (Tg); and
an outer layer disposed on each opposing major surface of the inner layer, the outer layer comprising a second glass powder and a second inorganic filler, wherein the outer layer has a second CTE and a second Tg,
wherein a CTE gap between the first CTE and the second CTE is between 10×10⁻⁷/° C. and
30×10⁻⁷/° C., and
wherein a difference between the first Tg and the second Tg is 10° C. or less.

9. The glass structure of claim 8, wherein the second inorganic filler is SiO₂ and comprises between 5 wt. % and 15 wt. % of a composition of the outer layer.

10. The glass structure of claim 8, wherein the first inorganic filler is ZrO₂ and comprises between 5 wt. % and 10 wt. % of a composition of the inner layer.

11. The glass structure of claim 8, wherein the glass structure has a hardness between 600 kgf/mm² and 660 kgf/mm².

12. The glass structure of claim 8, wherein the second inorganic filler is SiO₂ and comprises 15 wt. % of a composition of the outer layer, and wherein the first inorganic filler is ZrO₂ and comprises 5 wt. % of a composition of the inner layer.

13. The glass structure of claim 12, wherein the first CTE of the inner layer is between 85×10⁻⁷/° C. and 90×10⁻⁷/° C. and the second CTE of the outer layer is between 60×10⁻⁷/° C. and 75×10⁻⁷/° C.

14. The glass structure of claim 12, wherein the first Tg equals the second Tg.

15. A method of manufacturing a layered glass structure, comprising:
forming a first mixture having a predefined ratio of a first glass powder and a first inorganic filler;
forming a second mixture having a predefined ratio of a second glass powder and a second inorganic filler;
printing a first layer comprising the first mixture, wherein the first layer has a first transition temperature (Tg) and a first coefficient of thermal expansion (CTE) lower than a CTE of the first glass powder;
printing a second layer comprising the second mixture on the first layer, the second layer having a second Tg and a second CTE higher than a CTE of the second glass powder and higher than the first CTE;
printing a third layer comprising the first mixture on the second layer, wherein the third layer has the first CTE;
de-binding the first, second, and third layers; and
co-sintering the first, second, and third layers, wherein a CTE gap between the first CTE and the second CTE is between 10×10⁻⁷/° C. and 30×10⁻⁷/° C.

16. The method of claim 15, further comprising:
strengthening the glass structure with an ion exchange process.

17. The method of claim 15, wherein the first inorganic filler is ZrO₂ and the second inorganic filler is SiO₂.

18. The method of claim 15, wherein the step of co-sintering is performed at a temperature between 840° C. and 880° C. and at a pressure of 10⁻⁵ torr.

19. The method of claim 15, wherein a difference between the first Tg of the first and third layers and the second Tg of the second layer is 10° C. or less.

20. The method of claim 15, wherein the step of de-binding is performed at a temperature between 500° C. and 650° C.
